(19) United States
(12) Patent Application Publication
(10) Pub. No.: US 2013/0335002 A1
(43) Pub. Date: Dec. 19, 2013

(54) ELECTRIC VEHICLE SOLAR ROOF KIT

(71) Applicant: Sean Moore, Essex Ontario (CA)

(72) Inventor: Sean Moore, Essex Ontario (CA)

(21) Appl. No.: 13/919,523

(22) Filed: Jun. 17, 2013

Related U.S. Application Data
(60) Provisional application No. 61/661,056, filed on Jun. 18, 2012.

(51) Int. Cl. H02J 7/35; H02J 7/02

(52) U.S. Cl. CPC H02J 7/35; H02J 7/025
USPC 320/101

(57) ABSTRACT

A solar kit according to an exemplary aspect of the present disclosure includes, among other things, a solar module including a solar cell. A converter is configured to provide a continuous amount of power from said solar module to a battery pack.

### CROSS-REFERENCE TO RELATED APPLICATIONS

This application claims priority to U.S. Provisional Application No. 61/661,056, which was filed on 18 Jun. 2012 and is incorporated herein by reference.

### BACKGROUND

This disclosure generally relates to an electrical vehicle. More particularly, this disclosure relates to a solar roof kit for charging a battery pack of an electric vehicle.

A battery pack for an electric vehicle is charged using various approaches known in the industry. In one approach, a battery pack for a golf cart is connected to a grid interface to charge the battery pack. In another approach, a solar module is mounted to the electric vehicle to provide power to the battery pack. Power from the solar module is regulated by a controller, such as a Maximum Power Point Tracking (MPPT) system. The MPPT system maximizes the amount of power produced by each solar cell of the solar module by maintaining a predetermined operating voltage independent of the battery voltage. However, existing MPPT controllers do not provide a continuous charge to the battery pack, thereby resulting in a reduced operating life of the battery pack.

### SUMMARY

A solar kit according to an exemplary aspect of the present disclosure includes, among other things, a solar module including a solar cell having a non-linear rate of current output with respect to an instantaneous voltage of the solar cell. A converter is configured to provide a continuous amount of power from the solar module to a battery pack.

An electric vehicle according to an exemplary aspect of the present disclosure includes, among other things, a battery pack including a battery cell. A solar module includes a solar cell having a non-linear rate of current output with respect to an instantaneous voltage of the solar cell. A converter is configured to provide a continuous amount of power from the solar module to the battery pack.

A method of charging a battery according to another exemplary aspect of the present disclosure includes, among other things, connecting a solar cell to a battery, the solar cell having a non-linear rate of current output with respect to an instantaneous voltage of the solar cell, and providing a continuous amount of current from the solar cell to the battery.

These and other features disclosed herein can be best understood from the following specification and drawings, the following of which is a brief description.

### BRIEF DESCRIPTION OF THE DRAWINGS

FIG. 1 illustrates a side view of an electric vehicle solar roof kit mounted to an electric vehicle.

FIG. 2A illustrates a schematic view of the electric vehicle solar roof kit of FIG. 1.

FIG. 2B illustrates a schematic view of a second example of the electric vehicle solar roof kit of FIG. 1.

FIG. 3 illustrates a visual display of the solar roof kit of FIG. 1.

### DETAILED DESCRIPTION

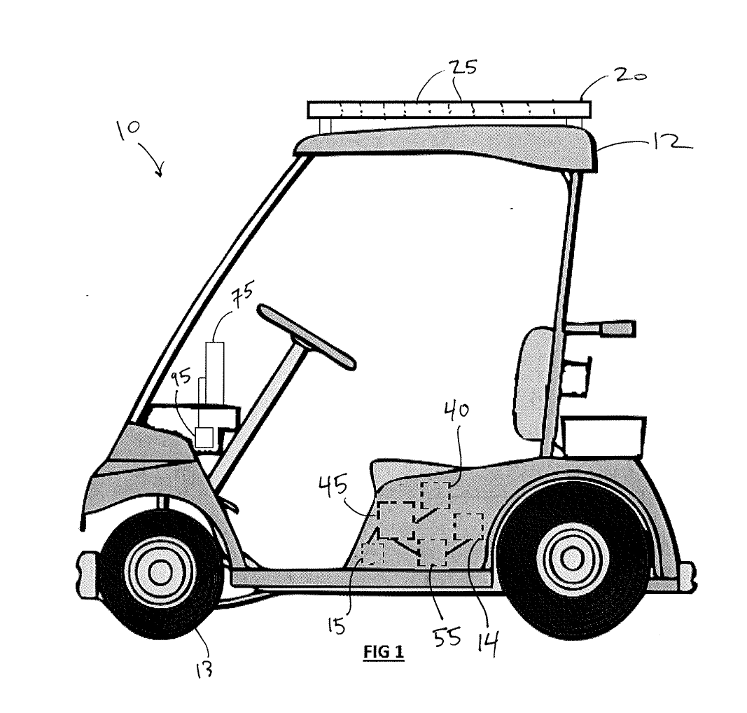

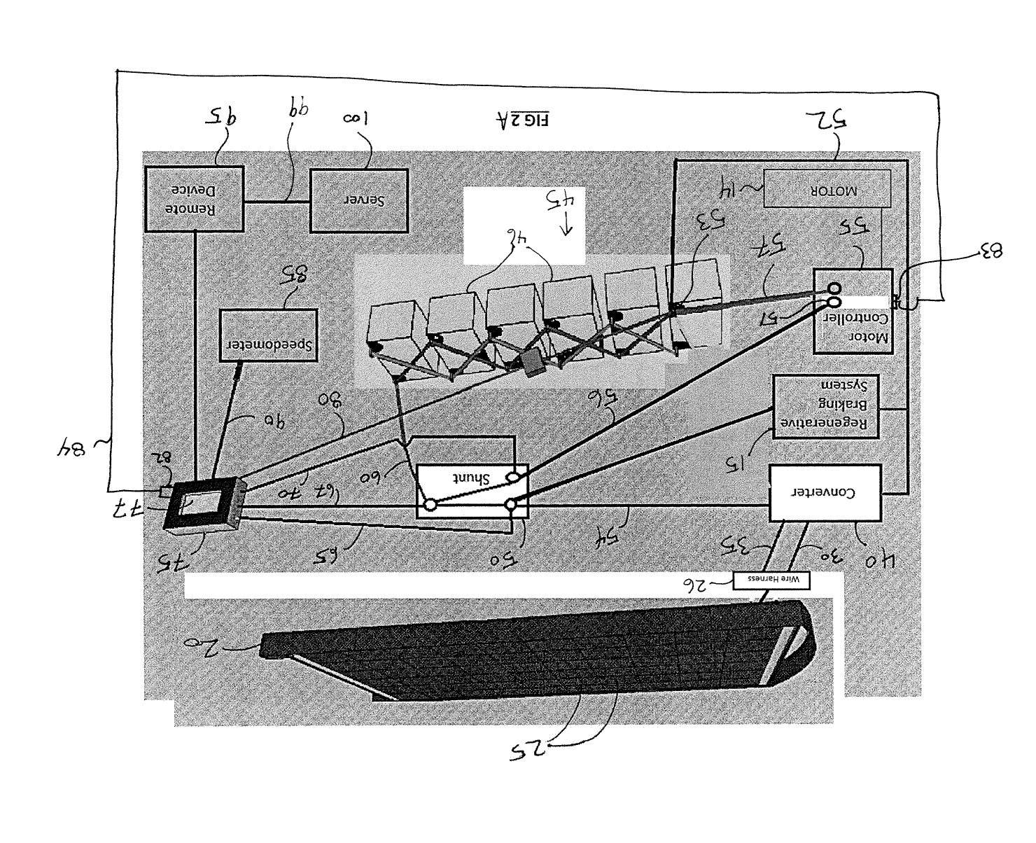

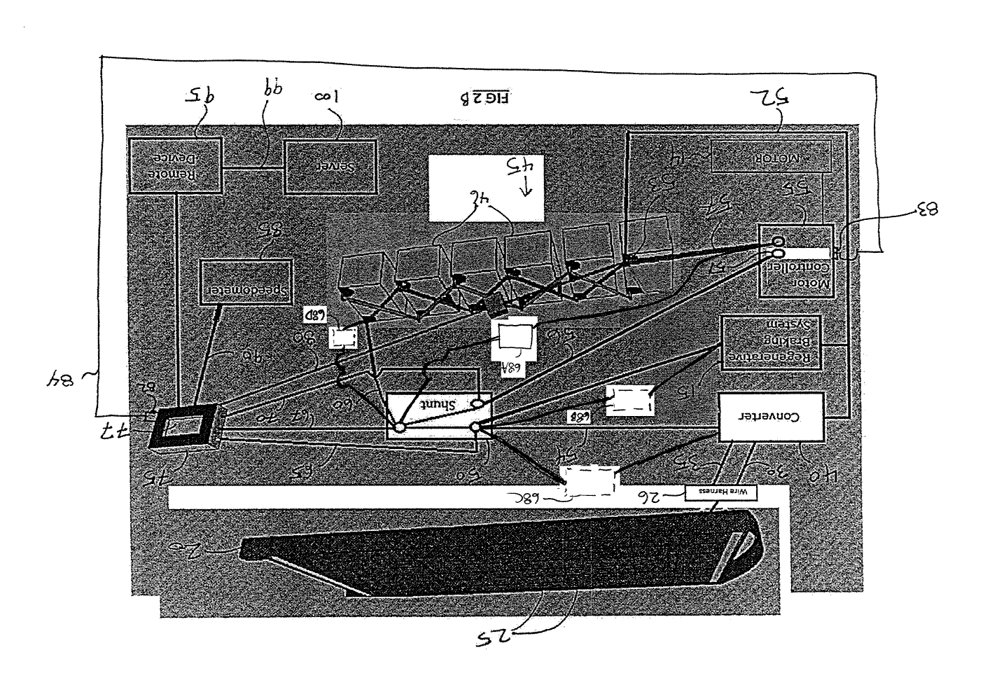

FIG. 1 illustrates a side view of an electric vehicle solar roof kit 10 mounted to an electric vehicle 11. In one example, the electric vehicle 11 is a golf cart. In another example, the electric vehicle 11 is a transit bus. In yet another example, the electric vehicle 11 is a railed vehicle system. Referring to FIG. 2A, the electric vehicle 11 includes a battery pack 45 for providing an amount of power to an electric motor 14. Generally, the battery pack 45 includes at least one battery cell 46. In one example, the electric vehicle 11 includes a regenerative braking system 15 configured to supply an amount of current to the battery pack 45.

The solar roof kit 10 includes a solar module 20. The solar module 20 includes a plurality of solar cells 25 (shown schematically) connected in series to each other. In one example, each of the solar cells 25 is a polycrystalline construction. Alternatively, the solar cells 25 may be of any other suitable construction, such as a monocrystalline construction. In one example, the solar module 20 has a substantially rectangular configuration and is mounted adjacent to a roof 12 of the electric vehicle 11. It should be appreciated that the solar module 20 may be configured in any combination of shape and dimension. The solar cells 25 of the solar module 20 are connected to a wire harness 26. The wire harness 26 is connected to a step-up converter 40 by a pair of first converter lines 30, 35.

The step-up converter 40 is operative to convert an input signal to an output signal having a greater direct current (DC) voltage than the input signal. In one example, the step-up converter 40 includes an inductor, a high speed switch such as a transistor, at least one capacitor, and a diode each connected to an integrated circuit board. The step-up converter 40 converts an open current voltage of the solar module 20 to a predetermine float voltage. The step-up converter 40 is connected to a positive terminal of the battery pack 45 by a second converter line 52 to provide an amount of current at the predetermined float voltage. Generally, the predetermined float voltage is defined as a value within a range of operating voltages of each battery cell 46 as determined by one of ordinary skill in the art. In one example, the predetermined float voltage is approximately 39.2 volts when the battery pack 45 operates at 36 volts or approximately 56.6 volts when the battery pack 45 operates at 48 volts. The predetermined float voltage can be within a suitable range for the battery pack 45, with the suitable range being determined by one skilled in the art having the benefit of this disclosure.

The step-up converter 40 outputs a continuous current to the battery pack 45. In this arrangement, the solar module 20 provides the continuous current to the battery pack 45 even though the solar module 20 may be operating in an off-peak state. The operation of the solar module 20 in the off-peak state is a result of each of solar cells 25 having a non-linear rate of current output with respect to an instantaneous voltage. Thus, the solar module 20 may operate in the off-peak state when each of the solar cells 25 discharges an amount of current when the instantaneous voltage of the solar cells 25 at a current time is below a predetermined operating voltage. Thus, it should be understood that the solar cells 25 may charge more efficiently when the instantaneous voltage is greater than or approximately equal to the predetermined operating voltage. In one example, the continuous current to the battery pack 45 is approximately 7.0 amps.

A continuous current provides the battery pack 45 with a continuous charge as long as the solar module 20 is operational, thereby eliminating the need to connect the battery pack 45 to a power source external to the electric vehicle 11 to charge the battery pack 45. In one example, the step-up converter 40 includes a bypass circuit connected to the output terminals of the step-up converter 40 for conditioning the output voltage of the step-up converter 40 and to protect the step-up converter 40 from a reverse current of the battery pack 45. In one example, the solar roof kit 10 includes a high-power shunt 50 connected to the step-up converter 40 by a third converter line 54. The high-power shunt 50 is connected to a negative terminal 51 of a motor controller 55 of the electric vehicle 11 by a first controller line 56. The motor controller 55 is electrically connected to a positive terminal 53 of the battery pack 45 by a second controller line 57, and a negative terminal of the battery pack 45 is electrically connected to the high-power shunt 50 at a battery line 60.

Referring to FIG. 2B, the solar roof kit 10 may include a secondary storage device 68a configured to receive an amount of energy from the solar module 20. The secondary storage device 68a may provide an amount of energy to the battery pack 45 or to the electric motor 52. An amount of energy may be provided to the secondary storage device 68a when the battery pack 45 is charging. An amount of energy may also be provided to the secondary storage device 68a when the battery pack 45 is fully charged and thereby recirculates an amount of current to the solar module 20. In this arrangement, the energy is stored in the secondary storage device 68a rather than being dissipated as heat in the solar cells 25 of the solar module.

In one example, the secondary storage device 68a is a capacitor. In another example, the secondary storage device 68a is a spare battery pack including at least one battery cell. The secondary storage device 68a is arranged between the motor controller 55 and the shunt 50 and in parallel to the battery pack 45. In other examples, any of the locations 68b, 68c and 68d can be used in the place of the secondary storage device 68a, as shown by dotted lines in FIG. 2B. However, other locations of the secondary storage device 68a are contemplated. In other examples, more than one secondary storage device 68a is used.

In one example, the solar roof kit 10 includes an electrical vehicle gauge 75 for observing the status of the battery pack 45. The gauge 75 includes a first controller (not shown) for calculating and storing a number of operating conditions of the electric vehicle 11 for later retrieval. The first controller may include, but is not limited to, a microprocessor or a single board computer. The gauge 75 calculates an amount of current being consumed by the motor 14 of the electric vehicle 11 and an amount of regenerative current being supplied to the battery pack 45 from the solar module 20 and the regenerative braking system 15 of the electric vehicle 11 based upon the voltages measured at the shunt 50.

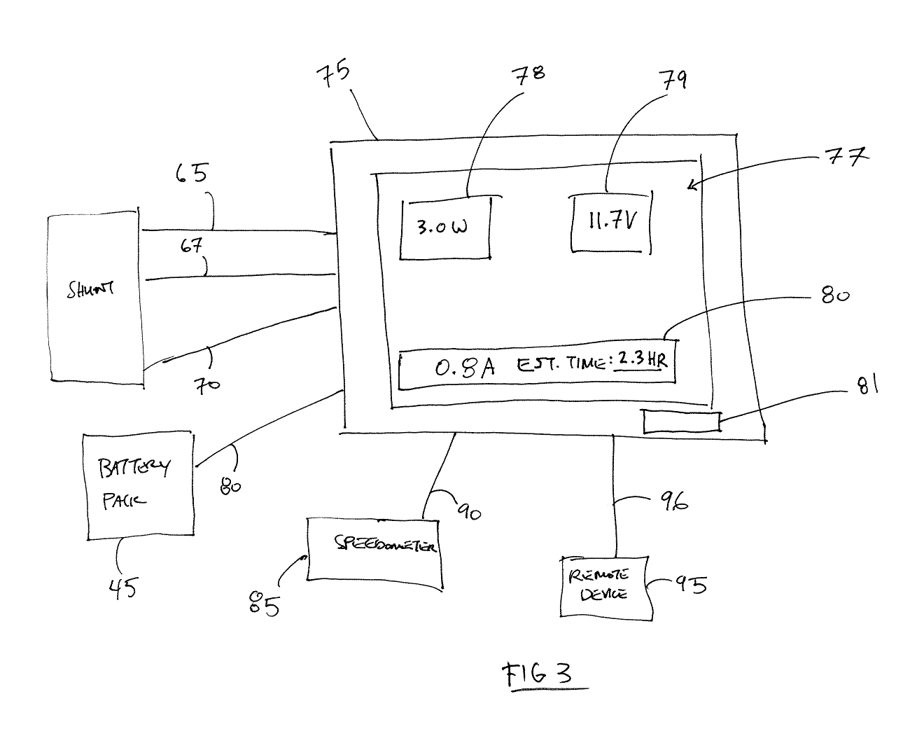

Referring to FIG. 3, the gauge 75 may include a visual display 77 connected to the computing device for displaying the operating conditions to an operator of the vehicle 11. In one example, the visual display 77 is a graphical user interface including a first window 78, a second window 79 and a third window 80. The first window 78 may display an amount of power being consumed by the motor 14, the second window 79 may display an instantaneous voltage of the battery pack 45, and the third window 80 may display an amount of regenerative current being supplied to the battery pack 45 from the solar module 20 and an estimated time for the battery pack 45 to be fully charged. However, the visual display 77 may be configured to display any operating condition observed by the gauge 75 and may include a different arrangement of the operating conditions. In another example, the visual display 77 includes a liquid crystal display (LCD). In another example, the visual display 77 includes a touch-screen configuration for responding to commands from the operator of the vehicle 11. In another example, the gauge 75 includes a warning indicator 81 (shown schematically) for providing a status of at least one of the operating conditions to the operator of the vehicle 11, such as a speaker for providing an audible signal when the charge of the battery pack 45 is less than a predetermined amount. In another example, the visual display 77 includes the warning indicator 81.

The gauge 75 is connected to each terminal of the high-power shunt 50 by a plurality of leads 65, 67, 70 for measuring the voltage across the terminals of the high-power shunt 50. The gauge 75 receives the voltage of the high-power shunt 50 and calculates a corresponding amount of current flowing between the battery pack 45 and the motor controller 55 based on the measured voltages. The gauge 75 is also capable of calculating the battery pack voltage, power output, net amperage hours drawn from or regenerated to the battery pack, Watt-hours or total energy drawn from the battery pack 45, Watt-hours produced from regenerative braking of the vehicle 11, percentage of power regeneration provided by the solar module 20 and by brake regeneration from the vehicle 11 in comparison to the total consumption of power from the battery pack 45, forward amp-hours and regenerative amperage-hours, peak regenerative current observed during operation, maximum amperage drawn from the battery pack 45, voltage sag of the battery pack 45 as compared to a predetermined operating voltage, and a running sum and a total sum of the lifetime amperage-hours drawn from the battery pack 45 depending on the requirements of a particular system. In another example, the gauge 75 estimates a duration for achieving a full charge in the case of off-peak operation of the solar module 20.

In some examples, the gauge 75 measures an amount of regenerative power provided to the battery pack 45 when the electric vehicle 11 is connected or plugged into a grid. Thus, the gauge 75 may be operable to maintain a constant running total of the amount of power provided to and discharged by the battery pack 45 for real-time evaluation. For example, the gauge 75 may be operable to predict the life of the battery pack 45 or at least one of the battery cells 46. In another example, the gauge 75 is operable to provide a recommended schedule for charging the battery pack 45 from the grid.

The gauge 75 may be operable to perform one or more limiting functions to reduce the amount of power consumed by the motor 52. The gauge 75 may include a first communications port 82 in electrical communication with a second communications port 83 of the motor controller 55 by way of a controller communications path 84. The controller communications path 84 may be analog or digital. The controller communications path 84 may also be a wired connection or a wireless connection. The gauge 75 is operable to send one or more limiting instructions based upon the limiting function to the motor controller 55. In one example, the limiting instruction is a desired speed of electric vehicle 11 corresponding to an output of the motor 52. In another example, the limiting instruction is a maximum amount of amperage to be provided to the motor 52. However, other limiting functions and limiting instructions are contemplated.

The gauge 75 is electrically connected to a speedometer 85 by a speedometer line 90. In one example, the speedometer 85 is mounted to a front wheel 13 (shown in FIG. 1) of the vehicle 11 for measuring a quantity of the wheel rotations. The speedometer 85 is configured to provide a wheel rotation signal to the gauge 75 in response to a rotation of the wheel 13. The gauge 75 calculates a distance traveled by the vehicle 11 as a function of the number of wheel rotations and a predetermined circumference of the wheel 13. The gauge 75 is also operable to calculate trip time and total distance traveled by the vehicle 11. In some examples, the gauge 75 calculates the current speed, average speed and maximum speed of the vehicle 11. The gauge 75 also calculates Watt-hours consumed per kilometer and Watt-hours consumed per mile.

In another example, the gauge 75 includes a data interface for transmitting the operating conditions of the vehicle 11 to a remote device 95 over a first communications path 96. The data interface of the gauge 75 is configured to send and receive data over the first communications path 96 by one or more of universal serial bus (USB), Ethernet, Wi-Fi, Bluetooth, or any other configuration suitable for data communications. The remote device 95 is configured to send and receive data from the gauge 75 over a second communications path 99 to a dedicated server 100 for real-time monitoring and analysis of the electric vehicle 11. The second communications path 99 may be Wi-Fi, cellular or Global Positioning Satellite Receiver (GPSr), or any other configuration suitable for data communications. In one example, the dedicated server 100 is capable of monitoring the operating condition of a plurality of electric vehicles 11 for fleet management and deployment. In another example, the dedicated server 100 can interface with the electric vehicle 11 and provide direct controls to the electric vehicle 11. The server 100 can be any remote device configured to control the electric vehicle 11.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the present disclosure.

What I claim is:

1. A solar kit comprising:
a solar module including a solar cell; and
a converter configured to provide a continuous amount of power from said solar module to a battery pack.

2. The solar kit of claim 1, wherein said converter is configured to convert an open current voltage of said solar module to a predetermined float voltage of the battery pack.

3. The solar kit of claim 1, wherein said converter includes a bypass circuit configured to regulate at least one of an amount of voltage and an amount of current between said converter and the battery pack.

4. The solar kit of claim 1, comprising a shunt electrically disposed between said converter and the battery pack.

5. The solar kit of claim 4, comprising a gauge configured to measure an amount of voltage of said shunt.

6. The solar kit of claim 5, wherein said gauge includes a first controller operable to calculate an operating condition based upon said voltage of said shunt.

7. The solar kit of claim 6, wherein said gauge includes a visual display operable to provide a visual representation based upon said operating condition.

8. The solar kit of claim 6, wherein said gauge includes a warning indicator configured to provide a status based upon said operating condition.

9. The solar kit of claim 1, wherein said solar cell has a non-linear rate of current output with respect to an instantaneous voltage of said solar cell.

10. An electric vehicle comprising:
a battery pack including a battery cell;
a solar module including a solar cell having a non-linear rate of current output with respect to an instantaneous voltage of said solar cell; and
a converter configured to provide a continuous amount of power from said solar module to said battery pack.

11. The electric vehicle of claim 10, comprising a shunt electrically disposed between said converter and said battery pack.

12. The electric vehicle of claim 11, comprising a gauge configured to measure an amount of voltage of said shunt.

13. The electric vehicle of claim 12, wherein said gauge includes a first controller operable to calculate an operating condition based upon said voltage of said shunt.

14. The electric vehicle of claim 13, wherein said gauge includes a data interface in data communication with a remote device configured to receive said operating condition from said remote device.

15. The electric vehicle of claim 14, wherein said remote device is in data communication with a server configured to receive said operating condition.

16. The electric vehicle of claim 12, comprising a speedometer configured to provide a wheel rotation signal to said gauge.

17. The electric vehicle of claim 11, wherein said shunt is electrically connected to a regenerative braking system.

18. A method of charging a battery, comprising:
connecting a solar cell to a battery, wherein said solar cell has a non-linear rate of current output with respect to an instantaneous voltage of said solar cell; and
providing a continuous amount of current from said solar cell to said battery.

19. The method as recited in claim 18, wherein said step of providing a continuous amount of current from said solar cell to said battery is performed when said instantaneous voltage of said solar cell is below a predetermined operating voltage.

20. The method as recited in claim 18, comprising the steps of:
calculating an operating condition based upon a measurement of at least one of said solar cell, said battery and a component in electrical communication with at least one of said solar cell and said battery;
connecting to a remote server; and
providing said operating condition to said remote server.
